(19) United States
(12) Patent Application Publication
(10) Pub. No.: US 2024/0193427 A1
(43) Pub. Date: Jun. 13, 2024

(54) METHOD FOR PREDICTING GEOLOGICAL FEATURES FROM THIN SECTION IMAGES USING A DEEP LEARNING CLASSIFICATION PROCESS

(71) Applicant: SHELL USA, INC., Houston, TX (US)

(72) Inventors: Oriol FALIVENE ALDEA, The Hague (NL); Lucas Maarten KLEIPOOL, The Hague (NL); Neal Christian AUCHTER, The Hague (NL)

(21) Appl. No.: 18/555,346

(22) PCT Filed: May 5, 2022
(86) PCT No.: PCT/EP2022/062162

§ 371 Date: Oct. 13, 2023

Related U.S. Application Data
(60) Provisional application No. 63/187,144, filed on May 11, 2021.

(51) Int. Cl. G06N 3/084

(52) U.S. Cl. CPC G06N 3/084

(57) ABSTRACT

A method for predicting an occurrence of a geological feature in a geologic thin section image uses a backpropagation-enabled classification process trained by inputting extracted training image fractions having substantially the same absolute horizontal and vertical length and associated labels for classes from a predetermined set of geological features, and iteratively computing a prediction of the probability of occurrence of each of the classes for the extracted training image fractions. The trained backpropagation-enabled classification model is used to predict the occurrence of the classes in extracted fractions of non-training geologic thin section images having substantially the same absolute horizontal and vertical length as the training image fractions.

### FIELD OF THE INVENTION

The present invention relates to backpropagation-enabled processes, and in particular, to a method for training a backpropagation-propagation classification process to identify the occurrence of geological features from images of thin sections.

### BACKGROUND OF THE INVENTION

An important method in hydrocarbon exploration and production is the description of images of thin sections. Thin sections are thin slices of rock (usually around 30 μm or 0.03 mm thick) that are attached to a glass slide and can be observed with a petrographic microscope. Thin sections are collected from subsurface rock samples (obtained by sampling subsurface cores or cuttings) or from outcropping rock samples. Commonly, multiple thin sections (usually in the order of hundreds) are collected to characterize the lateral and vertical microscopic heterogeneity within a volume of rock.

The microscopic characteristics obtained from the description of multiple thin sections, are then integrated with observations from other types of data in order to understand, delineate, and predict the different geological elements needed to find and optimize the production of hydrocarbon accumulations in the subsurface.

Using state-of-the-art petrographic microscopes, one or multiple images of each thin section can be digitally captured to obtain representative digital records that helps in the process of describing and documenting an entire thin section.

Each image captured is characterized by a number of pixels in the horizontal and vertical direction (i.e. resolution), and represents a determinate absolute dimension in the horizontal and vertical direction, the ratio between the number of pixels and the absolute dimensions defines the scale of the image, which is, in most cases, the same in the vertical and horizontal direction.

Observation of thin sections using the petrographic microscope or in images of thin sections allows experienced geoscientists to distinguish and describe a variety of microscopic geological features or rock characteristics. Usually, several features of the thin section are described, for example: mineralogical composition, rock texture classification, the origin, sizes and shapes of the particles or grains that form the rock, presence of porosity, presence and composition of diagenetic cements, presence and abundance of specific components that are diagnostic of the rock origin, amongst other aspects. Each geological feature that is described can be associated to a series of potential outcoming classes. For example, typical outcome classes of the rock texture classification for carbonate sedimentary rocks based on the Dunham classification scheme are mudstone, wackestone, packstone, grainstone, boundstone or crystalline; or typical outcome classes for the description of porosity types in carbonate sedimentary rocks based on the Choquette and Pray classification scheme are e.g., interparticle, intraparticle, intercrystalline, or molded; or typical outcome classes for the description of grain shapes applied to clastic rocks are rounded, subrounded, subangular or angular.

Due to the large number of thin sections that need to be described and the complexity of their description process, describing thin sections is a time consuming and repetitive task, which is prone to individual bias and/or human error. As a result, the thin sections descriptions may have inconsistent quality and format. Describing a collection of thin sections characterizing a rock volume may take an experienced geologist, for example, weeks or more to complete, depending, for example, on the specific amount of thin sections and geological complexity.

However, machine learning, and specifically the application of convolutional neural networks trained through a backpropagation-enabled process offer the opportunity to speed up time-intensive thin section description processes as well as obtaining more standardized descriptions without variable human bias using images of thin sections.

Cheng et al. (“Rock images classification by using deep convolution neural network” J. Phys.: Conf. Ser. 887:012089; 2017), Jobe et al. (“Geological Feature Prediction Using Image-Based Machine Learning” Petrophysics 59:06:750-760; 2018), Pires de Lima et al. (“Petrographic microfacies classification with deep convolutional neural networks” Computers & Geosciences 142:104481; 2020) use images of thin sections to train convolutional neural networks (CNN) using a classification approach.

Cheng et al. take 4800 images from the same oil field and normalize the size of them to 224×224 pixels, using 3600 of the images as a training set and the remaining as a test set. There is no indication in Cheng et al. regarding the true image scale. It is unclear as to whether the 4800 images were produced at the same optical magnifications, and, therefore the same resolution and scale. The only requirement is that the images are 224×224 pixels, regardless of original scale and resolution. Moreover, Cheng et al. do not explain how to apply the trained CNN to non-training/validation thin section images from a different dataset. There is no indication of image scale for non-training/validation thin section images.

Jobe et al. use images obtained with the same microscope and at the same resolution and scale (10× optical magnification) to train and validate the CNN. The CNN architecture used by Jobe et al. required that input images be limited to 300×300 pixels. Accordingly, Jobe et al. extracted 300×300 pixel images from the original images to create a training subset, a cross-validation subset and a testing subset. Jobe et al. discuss application of the trained model, stating that the unclassified images must be preprocessed and fed into the model in the same manner as they were during training—namely that smaller (300×300 pixel) sample images be extracted from the unclassified images. But, Jobe et al. state that the advantage of their CNN model is that it can be applied to unclassified images of any size because the model input requires that only 300×300 pixel images be used, independent of the resolution and scale of the original image.

Finally, Pires de Lima et al. use images obtained with the same microscope and at the same resolution and scale (10× optical magnification), from which 644×644 pixels fragments are extracted to train and validate the convolutional neural network. Pires de Lima et al. acknowledge that different lithological and diagenetic properties can only be analyzed in different scales. As an example, Pires de Lima et al. state that bioturbation evidence is obscured when cropping thin section images into smaller 10× photographs and, therefore, the thin section image should be captured in its entirety, instead of using fragments of the image.

Combining thin section images with multiple resolution and scales when preparing the training datasets is not addressed explicitly by Cheng et al. Meanwhile, Jobe et al. has a pixel limitation for their CNN architecture, but that the trained CNN model can be applied to different resolution and scale, as long as the image fraction is 300×300 pixels. And, finally, while Pires de Lima et al. state that different scales may be used for different lithological and diagenetic properties, but that when a model is trained at a specific magnification, different fragment sizes may be used in training, and therefore, is application of the trained model.

Koeshidayatullah et al. (“Fully automated carbonate petrography using deep convolutional neural networks” Marine and Petroleum Geology 122:2-16; 2020.104687) also shows the application of a convolutional neural network for image classification (in addition to object identification). However in the application of Koeshidayatullah et al., they compiled a training set of 4000 thin section images with different scales (or magnification), and resized the images to a constant dimension of 512×512 pixels and 224×224 pixels independently of their original resolution and scale, because their method aims to identify features in the thin sections that are independent on scale.

A disadvantage of convolutional neural network processes applied to date to the description of geological features from images of thin sections is a lack of scale awareness. When applying trained networks to additional datasets, the applicability of their workflows and methods to be deployed in real case studies is greatly limited because images of thin sections are commonly obtained using multiple microscopes with different optical magnifications and therefore resolution and scale.

There is a need for a method for training a backpropagation-enabled process for identifying the occurrence of each of the classes within a set of geological features that explicitly accounts for differences in resolution and scale within a set of training thin section images, as well as in the non-training images.

The resultant convolutional neural networks could then be trained and deployed to a multitude of datasets, without the limitations imposed using a single microscope set up or a single optical magnification. In addition, because training can be performed with more datasets, encompassing more varied geological settings, the predictions obtained by the convolutional neural networks in non-training thin sections images will be more accurate.

### SUMMARY OF THE INVENTION

According to one aspect of the present invention, there is provided a method for predicting an occurrence of a geological feature in an image of a thin section, the method comprising the steps of: (a) providing a trained backpropagation-enabled classification process, the backpropagation-enabled classification process having been trained by (i) providing a training set of thin section images; (ii) determining the scale of each of the thin section images in the training set; (iii) extracting training image fractions from the training set of thin section images, each extracted training image fraction having substantially the same absolute horizontal and vertical length; (iv) defining a set of geological features of interest, wherein the set of geological features comprises a plurality of classes; (v) selecting a class for labeling each of the training image fractions; (vi) inputting the extracted training image fractions with associated labeled classes into the backpropagation-enabled classification process; and (vii) iteratively computing a prediction of the probability of occurrence of the class in the extracted training image fractions and adjusting parameters in the backpropagation-enabled classification model accordingly, thereby producing the trained backpropagation-enabled classification process; and (b) using the trained backpropagation-enabled classification process to predict the occurrence of the class in a non-training thin section image by (i) providing a non-training thin section image; (ii) determining the scale of the non-training thin section image; (iii) extracting a non-training image fraction from the non-training thin section image, the extracted non-training image fraction having substantially the same absolute horizontal and vertical length as the extracted training image fraction used to train the networks; and (iv) inputting the extracted non-training image fractions to the trained backpropagation-enabled classification process; (v) predicting a probability of occurrence of the class on the extracted non-training image fraction; and (vi) combining the probabilities for the extracted non-training image fractions to produce an inference for the occurrence of the class in the non-training thin section image.

### BRIEF DESCRIPTION OF THE DRAWINGS

The method of the present invention will be better understood by referring to the following detailed description of preferred embodiments and the drawings referenced therein, in which:

FIG. 1 illustrates an embodiment of a first aspect of the method of the present invention for training a backpropagation-enabled classification process for classes of a set of geological features;

FIG. 2 illustrates another embodiment of the first aspect of the method of the present invention for training a number of backpropagation-enabled classification processes for classes of a number of sets of geological features;

FIG. 3 illustrates an embodiment of a second aspect of the method of the present invention for using the trained backpropagation-enabled classification process of FIG. 1 to predict classes of a set of geological features of a non-training thin section image; and

FIG. 4 illustrates another embodiment of the second aspect of the method of the present invention for using the trained backpropagation-enabled process of FIG. 1 to predict a trend of probabilities for inferences for classes of a set of geological features from non-training thin section images at different depths.

### DETAILED DESCRIPTION OF THE INVENTION

The present invention provides a method for predicting the occurrence of each of the classes characterizing a geological feature in a geologic thin section image. A geological feature of interest can include, but is not limited to, texture type (such as Dunham texture type), grain size, grain type, cement type, mineral type, rock type, pore size, and porosity type (such as Choquette and Pray porosity type).

Each set of geological features has associated a plurality of classes. For example, typical classes of the texture types applied to carbonate sedimentary rocks include, without limitation, mudstone, wackestone, packstone, grainstone, boundstone or crystalline textures. As another example, typical classes for porosity type applied to carbonate rocks are, without limitation, interparticle, intraparticle, intercrystalline, or molded porosity types.

The trained backpropagation-enabled classification process may be also used to assess a trend in the geological features over a span of vertical and/or horizontal distances in a time-efficient manner with better resolution and accuracy than conventional processes.

Geologic features control the capacity of the rocks in the subsurface to store and produce hydrocarbons, and therefore consistent and quick descriptions of these rocks can be particularly useful information for those skilled in the art of hydrocarbon exploration and/or production.

### Backpropagation-Enabled Process

The method of the present invention includes the step of providing a trained backpropagation-enabled classification process.

Examples of backpropagation-enabled processes include, without limitation, artificial intelligence, machine learning, and deep-learning. It will be understood by those skilled in the art that advances in backpropagation-enabled processes continue rapidly. The method of the present invention is expected to be applicable to those advances even if under a different name. Accordingly, the method of the present invention is applicable to the further advances in backpropagation-enabled processes, even if not expressly named herein.

A preferred embodiment of a backpropagation-enabled process is a deep learning process, including, but not limited to, a convolutional neural network.

The backpropagation-enabled process may be supervised, semi-supervised, or a combination thereof. In one embodiment, a supervised process is made semi-supervised by the addition of an unsupervised technique. As an example, the unsupervised technique may be an auto-encoder step.

In accordance with the present invention, the method for training the backpropagation-enabled classification process involves inputting extracted training image fractions labeled with classes of the set of geological features of interest into the backpropagation-enabled classification process.

### Training Images and Associated Labels

Training thin section images may be collected in a manner known to those skilled in the art using a petrographic microscope to investigate thin sections of subsurface or outcropping rock samples. In a preferred embodiment, thin sections are produced from rock samples obtained from a hydrocarbon-containing formation or other formations of interest. In a preferred embodiment, a sample of the subsurface rock is obtained by coring a portion of the formation from within a well in the formation as a whole core. In another embodiment, the cores can be collected from drilling small holes on the side of the wellbore; these are known as side-wall cores.

A training set of thin section images is provided. Preferably, the scale of each thin section image in the training set is determined, each thin section image having a characteristic resolution or number of pixels across the horizontal or vertical direction. The scale of each thin section image in the training set is determined by the number of pixels that corresponds to the length of the graphic scale bar (for example, referred to as pixels per unit length), which is usually overlain on top of the thin section image, subdivided by the absolute dimensions that the graphic scale bar represents, which is next to the graphic scale bar on top of the thin section image. Scale of thin section images is typically represented as 1D, because vertical and horizontal scaling is preferably the same. However, the scale may not be the same for each thin section image in the training set. In one embodiment of the present invention, the thin section images are scaled to be substantially the same before extracting the training image fractions.

Training image fractions are extracted from the training set of thin section images. In one embodiment of the present invention, the training image fractions have substantially constant absolute dimensions across all the fractions from all the training images, which means that the absolute length across the horizontal direction is substantially the same for all the fractions, independent of the original scale or resolution of the training images, and that the absolute length across the vertical direction is also substantially the same for all the fractions, independent of the original scale or resolution of the training images. The dimensions of the target image fractions multiplied by the scale of the thin sections determines the size in pixels that need to be extracted to generate the image fractions for each thin section image.

In the case where the training thin section images have been scaled to substantially the same scale, the extracted training image fractions will be of substantially the same number of pixels. In the case where the training thin section images have different scales, the extracted training image fractions will have different number of pixels, selected such that the absolute horizontal and vertical length that those pixels represent will be substantially the same. Alternatively, the extracted training image fractions are selected to be the same size and then rescaled to substantially the same absolute scale. Preferably, the extracted image fractions have substantially the same absolute horizontal and vertical length, within ±10% deviation, more preferably within ±5% deviation.

Thin section images may be captured under different types of light conditions. For example, the images may be produced under polarized light to make certain classes of geological features more evident. Alternatively, a thin section image may be produced after using a chemical reactive on the thin section (i.e. staining the thin section) to make certain classes of geological features easily distinguishable.

In order to be suitable for training the backpropagation-enabled classification processes, each extracted training image fraction is labeled with a class from a plurality of classes within a set of geological features of interest. The extracted training image fractions with associated labeled classes are input into the backpropagation-enabled classification process.

Since assigning the associated labeled class for each of the extracted training image fractions in real data is done manually, and therefore can be time consuming when large number of labeled image fractions are needed, the information from the extracted image fractions may be augmented by flipping the image fractions in the vertical and horizontal direction, by slightly shifting or cropping the images in the vertical and horizontal direction.

Data augmentation can also be achieved with numerical simulations of one or more classes of the set of geological features blended with the original thin section image, and therefore automatically assigning the associated labels for those simulated classes without manual labelling.

In another embodiment the original thin section images can be replaced, in whole or in part, by numerically generated synthetic images and their numerically derived associated labels in order to avoid manual labelling.

In one embodiment of the present invention, an additional set of geological features of interest is defined. The additional set of geological features comprises a plurality of additional classes. The extracted training image fractions are labeled with one or more additional classes for the additional set of geological features of interest.

### Backpropagation-Enabled Classification Process Training

The extracted training image fractions are input to the backpropagation-enabled process with associated labeled classes. In the embodiment of the present invention where an additional set of geological features of interest is selected, extracted training image fractions and associated labeled classes for the additional set of geological features are input to an additional backpropagation-enabled process. Preferably, the additional backpropagation-enabled classification process is trained using substantially the same absolute scale for the extracted image fractions.

Preferably, the training process steps are iterated to improve the quality and accuracy of the output probabilities of occurrence of a class in a thin section image.

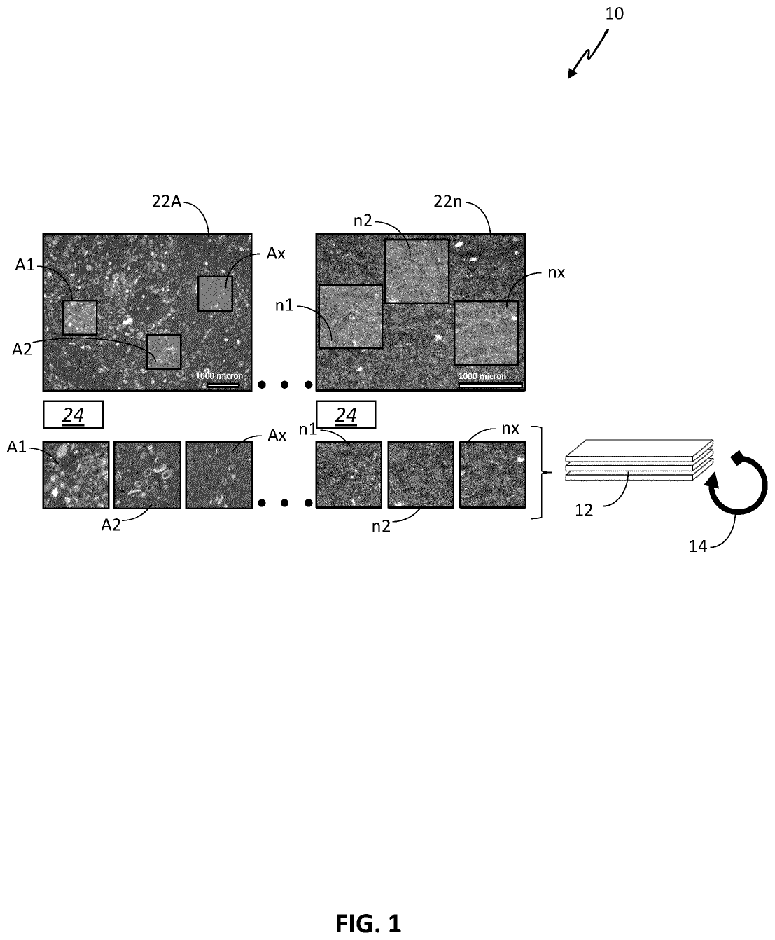

Referring now to the drawings, FIG. 1 illustrates a preferred embodiment of a first aspect of the method of the present invention 10 for training a backpropagation-enabled process 12 for classes of a set of geological features. In this embodiment, a set of training thin section images 22A-22n are provided. Training image fractions A1-Ax . . . n1-nx are extracted from the training thin section images 22A-22n, respectively. The extracted training image fractions A1-Ax . . . n1-nx are inputted to the backpropagation-enabled process 12, together with associated labels representing classes of the set of geological features 24. As can be seen from the dimension bars representing, as an example, 1000 microns, in FIG. 1, the magnification of thin section image 22n is larger than the magnification of thin section 22A. Accordingly, the size of the extracted training image fractions A1-Ax is smaller than that of extracted images n1-nx, so that the extracted training image fractions A1-Ax . . . n1-nx will have substantially the same absolute scale dimensions.

The training images 22A-22n and extracted image fractions A1-Ax . . . n1-nx are for illustrative purposes only. The number of extracted training image fractions A1-Ax . . . n1-nx need not be the same for each of the training images 22A-22n. The training image fractions A1-Ax . . . n1-nx may also be extracted from the thin section images 22A-22n in such a manner that the image fractions have overlapping portions or may be taken at an angle.

The labels correspond to the presence or absence of a class for the selected set of geological features 24 in each extracted training image fractions A1-Ax . . . n1-nx.

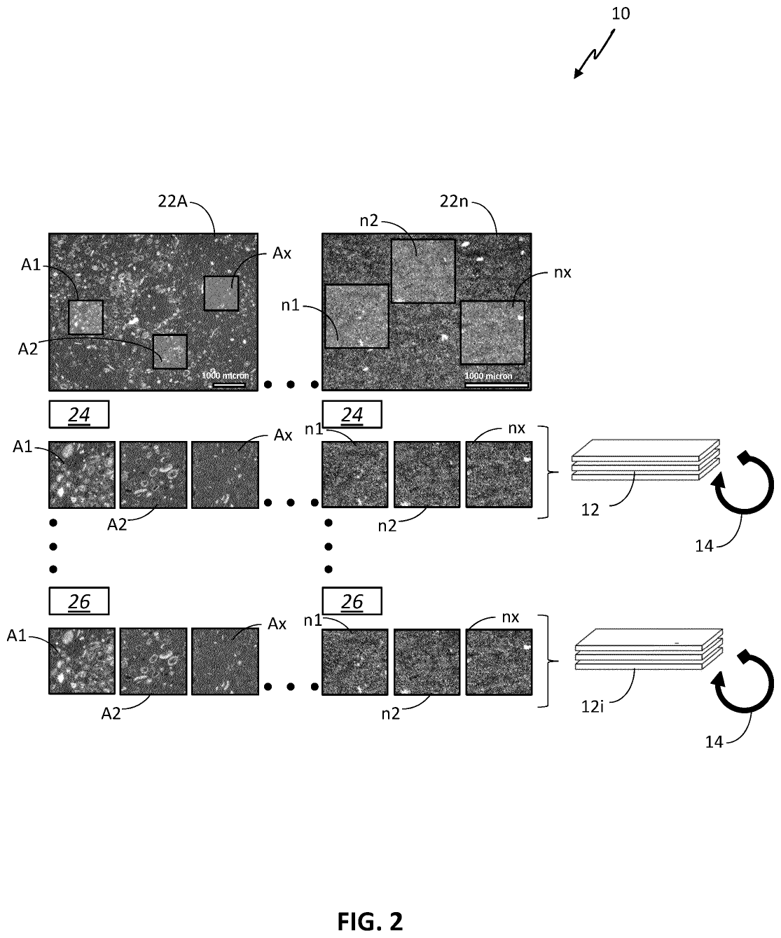

FIG. 2 illustrates another preferred embodiment of a first aspect of the method of the present invention 10 for training a backpropagation-enabled process 12. In this embodiment, the extracted training image fractions A1-Ax . . . n1-nx are labeled with classes of one or more additional sets of geological features 26. The extracted training image fractions A1-Ax . . . n1-nx are inputted to an additional backpropagation-enabled process 12i.

Referring to both FIGS. 1 and 2, the backpropagation-enabled process 12, 12i trains a set of parameters. The training is an iterative process, as depicted by the arrow 14, in which the prediction of the probability of occurrence of the class of geological features 24, 26 is computed, this prediction is compared with the input labels, and then, through backpropagation processes, the parameters of the model 12, 12i are updated.

The iterative process involves inputting a variety of extracted thin section image fractions representing classes of the set of the geological features, together with their associated labels during an iterative process in which the differences in the predictions of the probability of occurrence of each geological feature and the labels associated to the images of cores are minimized. The parameters in the model are considered trained when a predetermined threshold in the differences between the probability of occurrence of each geological feature and the labels associated to the images is achieved, or the backpropagation process has been repeated a predetermined number of iterations.

In a preferred embodiment, the training step includes validation and testing. Preferably, results from using the trained backpropagation-enabled classification process are provided as feedback to the process for further training and/or validation of the process.

Inferences with Trained Classification Process

Once trained, the backpropagation-enabled classification process is used to predict the occurrence of classes representative of the selected set of geological features in a non-training thin section image. Non-training image fractions are extracted from the non-training image fraction, after determining the resolution and scale of the non-training image. The extracted non-training image fractions having substantially the same absolute scale as the extracted training image fractions used to train the backpropagation-enabled classification process.

The extracted non-training image fractions are then input to the trained backpropagation-enabled process. Probabilities of occurrence of each of the classes of the set of geologic features are predicted for the extracted non-training images fractions. Probabilities are then combined for the extracted non-training image fractions to produce an inference for the probability of each of the classes in the set of the geologic features in the non-training thin section image.

In the embodiment where an additional backpropagation-enabled process is trained for an additional set of geologic features, probabilities of occurrence of each of the additional classes are predicted for the extracted non-training images fractions. Probabilities are then combined for the extracted non-training image fractions to produce an inference for the occurrence of the additional class in the non-training thin section image. Preferably, the additional backpropagation-enabled classification process is trained using substantially the same absolute scale for the extracted image fractions. In one embodiment, the inferences for classes of different sets of geological features are combined for non-training thin section images.

In a preferred embodiment, the non-training thin section images have associated geospatial metadata. Examples of geospatial metadata include, without limitation, well name, sample depth, well location, and combinations thereof.

In another embodiment, the non-training thin section images have associated characteristic metadata. Examples of characteristic metadata include, without limitation, resolution of the image, type of light conditions used in the capturing the image, indication of staining of the sample, and combinations thereof.

In a preferred embodiment, inferences for thin section images for different depths of a core are combined to show a trend of the classes of a set of geological features.

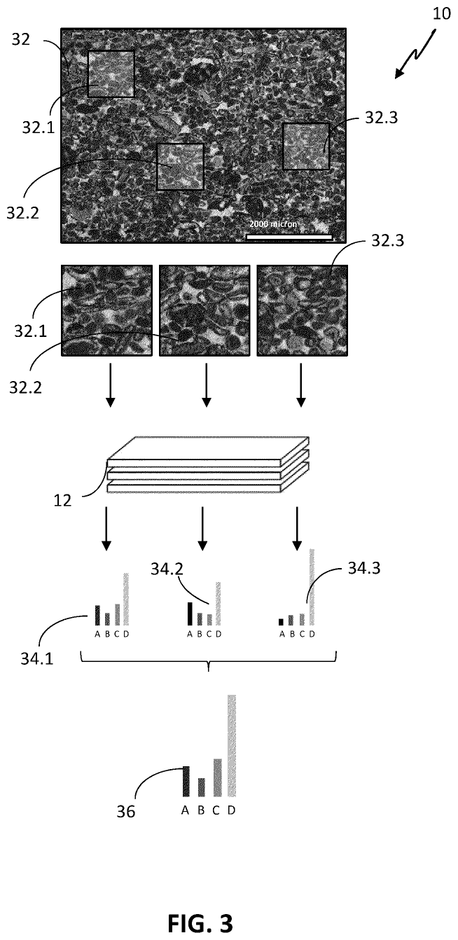

Turning now to FIG. 3, non-training image fractions 32.1, 32.2, 32.3 are extracted from a non-training thin section image 32. The extracted non-training image fractions 32.1, 32.2, 32.3 have substantially the same absolute dimensions as the extracted training image fractions A1-Ax . . . n1-nx. The extracted non-training image fractions 32.1, 32.2, 32.3 are fed to a trained backpropagation-enabled classification process 12.

Predictions 34.1, 34.2, 34.3 are produced showing the probability of occurrence of classes A, B, C, D in extracted non-training image fractions 32.1, 32.2, 32.3, respectively.

In a preferred embodiment, the predictions 34.1, 34.2, 34.3 showing the probability of occurrence of classes A, B, C, D are combined to produce an inference 36 of classes A, B, C, D for the non-training thin section image 32.

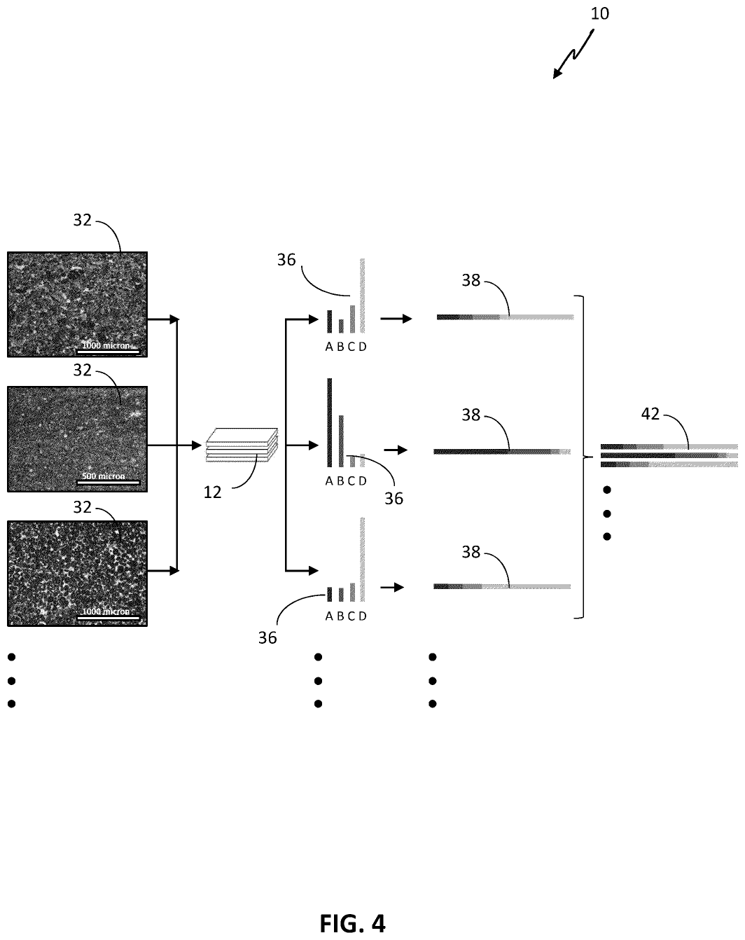

In FIG. 4, extracted image fractions (not shown) for non-training thin section images 32 were input to the trained backpropagation-enabled process 12. The non-training thin section images 32 were provided for different depths of a well. A probability of occurrence of classes A, B, C, D were predicted for each extract image fraction and combined into an inference 36 for each thin section image 32. The display purposes, the histograms for the inferences 36 were transformed into linear bars for classes A, B, C, D. The linear bars 38 were then combined into display 42 to show the trend for classes A, B, C, D by depth.

This type of display helps identify vertical trends in class frequency or distribution vs. depth, which can reveal clues to processes that led to deposition of rocks and/or capacity of rock to store and produce hydrocarbons and the best way to extract these resources.

While preferred embodiments of the present invention have been described, it should be understood that various changes, adaptations and modifications can be made therein within the scope of the invention(s) as claimed below.

What is claimed is:

1. A method for predicting an occurrence of a geological feature in an image of a thin section, the method comprising the steps of:
(a) providing a trained backpropagation-enabled classification process, the backpropagation-enabled classification process having been trained by
i. providing a training set of thin section images;
ii. determining the scale of each of the thin section images in the training set;
iii. extracting training image fractions from the training set of thin section images, each extracted training image fraction having substantially the same absolute horizontal and vertical length;
iv. defining a set of geological features of interest, wherein the set of geological features comprises a plurality of classes;
v. selecting a class for labeling each of the training image fractions;
vi. inputting the extracted training image fractions with associated labeled classes into the backpropagation-enabled classification process; and
vii. iteratively computing a prediction of the probability of occurrence of the class in the extracted training image fractions and adjusting parameters in the backpropagation-enabled classification model accordingly, thereby producing the trained backpropagation-enabled classification process; and
(b) using the trained backpropagation-enabled classification process to predict the occurrence of the class in a non-training thin section image by
i. providing a non-training thin section image;
ii. determining the scale of the non-training thin section image;
iii. extracting a non-training image fraction from the non-training thin section image, the extracted non-training image fractions having substantially the same absolute horizontal and vertical length as the extracted training image fractions used to train the backpropagation-enabled classification process; and
iv. inputting the extracted non-training image fractions to the trained backpropagation-enabled classification process;
v. predicting a probability of occurrence of the class on the extracted non-training image fractions and;
vi. combining the probabilities for the extracted non-training image fractions to produce an inference for the occurrence of the class in the non-training thin section image.

2. The method of claim 1, further comprising the steps of:
defining an additional set of geological features of interest, wherein the additional set of geological features comprises a plurality of additional classes;
selecting an additional class for labeling each of the extracted training image fractions;
training an additional backpropagation-enabled classification process for predicting the probability of occurrence of the additional class on the extracted non-training image fraction by inputting the extracted non-training image fractions to the additional backpropagation-enabled classification process; and
combining the probabilities for the extracted non-training image fractions to produce an inference for the occurrence of the additional class in the non-training thin section image.

3. The method of claim 1, wherein the set of geological features is selected from sets of texture types, grain sizes, grain types, cement types, mineral types, rock types, pore sizes, and porosity types.

4. The method of claim 1, wherein the predictions for each non-training image fraction are combined by summing, multiplying, probabilities and selecting the class that has highest combined probability.

5. The method of claim 2, further comprising the step of combining the inference produced in step (b)(v) and the inference for the additional class.

6. The method of claim 1, wherein the extracted image fractions have an absolute horizontal and vertical length within ±10% deviation, more preferably within ±5% deviation.

7. The method of claim 1, wherein the non-training thin section images has associated geospatial metadata.

8. The method of claim 1, wherein the non-training thin section images has associated characteristic metadata.

9. The method of claim 1, wherein inferences for thin section images for different depths are combined to show a trend for one or more of the plurality of classes.

10. The method of claim 1, wherein the extracted training image fractions are augmented with numerical simulations of one or more of the plurality of classes.

11. The method of claim 1, wherein the training thin section image is selected from the group consisting of images of real thin section images, real thin section images modified with numerical simulations of one or more of the plurality of classes, synthetic thin section images from numerical simulations, and combinations thereof.
